(19) United States
(12) Patent Application Publication
(10) Pub. No.: US 2001/0031043 A1
(43) Pub. Date: Oct. 18, 2001

(54) Network connection apparatus and method using internet phone

(75) Inventor: Hyun Joon Kim, Kyunggi-Do (KR)

Correspondence Address: Jonathan Y. Kang, ESQ., LEE & HONG P.C., 11th Floor, 221 N. Figueroa Street,, Los Angeles, CA, 90012-2601, US

(73) Assignee: LG Electronics Inc.

(21) Appl. No.: 09/836,662

(22) Filed: Apr. 17, 2001

(30) Foreign Application Priority Data
Apr. 18, 2000 (KR) 20317/2000

(51) Int. Cl. H04M 11/00; H04L 12/66

(52) U.S. Cl. 379/90.01; 370/352; 370/353

(57) ABSTRACT

The present invention relates to a network connection apparatus using an internet phone and a method of the same, the apparatus comprises an internet phone main unit usable as an ordinary telephone or an internet phone in accordance with an operation of a user, a function extending unit for interfacing a function pack and a network CPU unit performing an independent function respectively, and a network CPU unit for controlling an audio signal transmitted/received through a PSTN and controlling a signal received from a network by controlling the Internet phone main unit and function extending unit. Accordingly, the present invention is capable of communicating with a plurality of wire IP phones with one line, and operating a multifunction digital apparatus with a moderate expense, and upgrading the apparatus easily.

### BACKGROUND OF THE INVENTION

1. Field of the Invention

The present invention relates to a network connection apparatus using an internet phone and the network connection method of the same, in particular to a network connection apparatus and method using an internet phone which is capable of performing upgrade and installation easily, and performing a multifunction network by using the internet phone as a networking hub in the general home.

2. Description of the Prior Art

Recently, while all countries have been connected with the internet, a LAN (Local Area Network) for connecting to the internet has been a major communication means.

According to this, offices having both a telephone network and the LAN increase. However, because the telephone network and LAN are constructed with an independent network respectively, a double expense occurs in maintenance of them. In order to solve the problem, the telephone network is replaced into the LAN in certain areas, a terminal (hereinafter, internet phone) operation in the LAN is used for a telephone call.

As described above, an ethernet line is required in order to use the internet phone, however most of ethernet users have only one ethernet line, accordingly an additional ethernet line has to be installed or a hub system has to be constructed in order to use terminals excluding a computer etc.

Because additional installation expense occurs in increase of the ethernet line or in construction of the hub system and consent facilities for supplying additional power is required in construction of the hub system, the surroundings may be complicated due to lots of lines, and the lots of lines may cause an accident.

The above-mentioned problem occurs in home as well as in offices.

In the prior art, in order to contact to the internet in home a modem is required. However, various leased-line services (ADSL, ISDN, HDSL etc.) having a fixed-rate system are introduced in recent years, and its market is expanded gradually from offices to home such as a SOHO (Small Office Home Office). In addition, new digital equipment such as a DVD etc. is introduced, accordingly construction of a network system is required for efficient connection with various networks.

After constructing the network system, a hub apparatus has to be installed in order to connect a plurality of computers and digital equipment. However, because the hub apparatus is expensive and requires big space, it is not efficient.

There is a network intergrated PC, a network equipment, a TV set top box etc. for network construction in home.

The network intergrated PC can perform a network hub function by interfacing a hub card with a PC.

The network intergrated PC has the good performance in contradiction to price, and does not require big space. But, because it has to be an ON state always in order to perform the hub function, a hard disk and a peripheral device having no direct relation to the network have to be an ON state also. Accordingly, power consumption increases and life span of the computer decreases.

In addition, because furniture and home appliances are placed on the side wall of a living room or a bed room in most of homes, when the PC for hub is installed in the living room, it is uncomfortable to work, when the PC is installed in the bed room separately, wiring work has to be done centering around the TV, herein the work is so troublesome and wall surface or circumstances can be messy due to the wiring.

The network equipment is an apparatus for contacting to a network corresponding to a module inserted by a user, the network equipment can not access to the network from the peripheral device such as a TV etc.

The TV set top box is for performing web shopping and networking with a TV by being installed to the TV, herein because a module is installed to the TV set top box, the other module corresponding to the other network can not be used, and the module can not be upgraded.

### SUMMARY OF THE INVENTION

An object of the present invention is to provide a network connection apparatus using an internet phone and a method of the same which is inexpensive and easily upgradable, and is capable of constructing a network easily by using the internet phone as a hub while maintaining a telephone function.

In order to achieve the object of the present invention, the network connection apparatus using the internet phone in accordance with an embodiment of the present invention comprises an internet phone main unit usable as an ordinary phone or an internet phone according to an operation of a user, a function extending unit for interfacing function packs with a CPU unit performing an independent function respectively, and a network CPU unit for controlling an audio signal transmitted/received to an ordinary telephone network and controlling a signal received from a network by controlling the internet phone set and function extending unit.

The network connection method using the internet phone in accordance with the present invention comprises setting-up a call when an audio signal is transmitted from outside through the ordinary telephone network/IP network, to sampling the transmitted analog-audio signal with a PCM digital signal in the ordinary telephone network, judging whether the PCM digital signal is connected by wire or wireless according to an IP or a unit address, and transmitting the PCM digital signal to the internet phone main unit by wire or transmitting the PCM digital signal to the PCI module by wireless according to judgement result.

In a method for originating a call by using an internet phone, a network connection method using an internet phone in accordance with the present invention comprises pressing a certain keypad of a PSTN set as a default in a network CPU module by a user or selecting an internet phone in a menu on a LCD screen by a user, inputting an IP address of the other party, and originating a call by setting up a VOIP-related protocol by the inputted IP address,

The network connection method using an internet phone in accordance with the present invention comprises accessing to the internet by a network CPU unit through a network interface pack when a user requests the internet contact, and displaying data transmitted to the network interface pack on a TV through a graphic-sound pack by using an execution program etc of the network CPU unit or listening data with an audio.

### BRIEF DESCRIPTION OF THE DRAWINGS

FIG. 1 illustrates a construction of a network connection apparatus using an internet phone in accordance with the present invention.

FIG. 2 is a block diagram illustrating a construction of the network connection apparatus using the internet phone of FIG. 1 in accordance with the present invention in detail.

FIG. 3 is a block diagram illustrating a bus interface of each function pack connectable to a function extending unit in accordance with the present invention.

FIG. 4 is a block diagram illustrating a telephone communication method in accordance with the present invention.

FIG. 5 is a block diagram illustrating a telephone communication method using a wireless IP phone in accordance with the present invention.

FIG. 6 is a block diagram a main unit of an apparatus and a connection method in accordance with the present invention.

FIG. 7 is a block diagram illustrating a method for expanding the performance of a CPU and a graphic-audio in accordance with the present invention.

### DETAILED DESCRIPTION OF THE PREFERRED EMBODIMENT

A network connection apparatus using an internet phone and a method of the same in accordance with the present invention will now be described with reference to accompanying drawings.

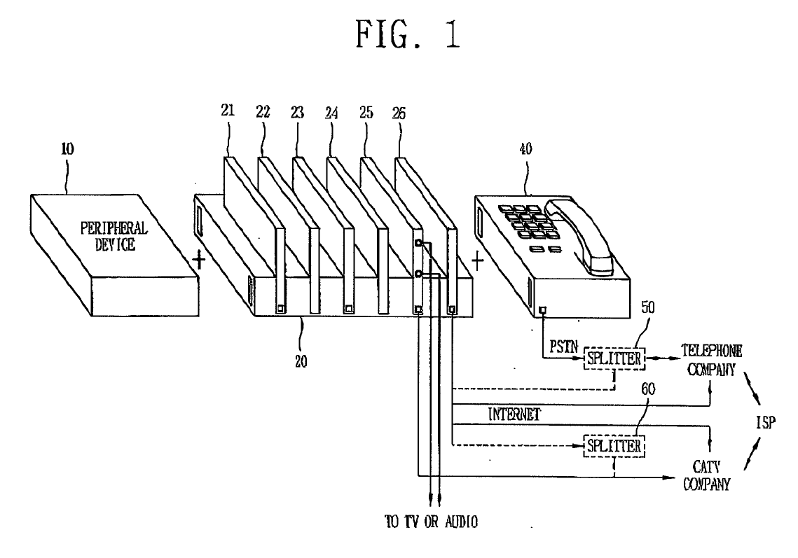

FIG. 1 illustrates a construction of the network connection apparatus using the internet phone in accordance with the present invention. The apparatus comprises an internet phone main unit 40 for performing a telephone communication through an internet leased-line or an ordinary telephone line, a function extending unit 20 for performing a hub function among communication channels or various terminals by combining to the internet phone main unit 40 or interfacing various function packs, and a peripheral device 10 for using peripherals jointly in each apparatus connected to the network by combing to the internet phone main unit 40 or function extending unit 20.

The various function packs interfaced in the function extending unit 20 comprises a network interface pack 26, a graphic-sound pack 25, a wireless LAN pack 24, an IEEE 1394 pack 23, an additional CPU pack 22, and an extension graphic-sound pack 21.

The network interface pack 26 performs a communication by a MAC protocol which is adaptable according to a very high speed internet service (xDSL, ISDN, ATM, cable Modem etc.) selected by a user, and a PCT interface unit is installed to it in order to communicate with the other function pack and a network CPU 30.

The graphic-sound pack 25 outputs video and audio of the selected channel or displays the internet or a computer game on a TV screen by tuning in to a signal inputted from a company providing a service to a cable TV.

The wireless LAN pack 24 connects to each terminal to construct the network by using a wireless radio without using a cable, there is no need to perform wiring work of each terminal, accordingly space utilization can be improved.

The wireless LAN pack 24 is transmitted with a bit rate of 2 Mbps in a wireless frequency range of 2.4 GHz by a standard 802.11 largely used at the present time, when a quicker wireless LAN standard is designated, it is possible replace a pack in accordance with the new standard, accordingly the performance can be upgraded more easily.

The IEEE 1394 pack 23 is for connecting directly a peripheral CPU such as a DVD-ROM, a hard disk etc. which is difficult to combine in the present wireless LAN technology with an IEEE 1394 which communicates with a memory address having a broad bandwidth relatively.

Because load is too big for processing the graphic-sound pack 25 with only a main CPU 30c of the network CPU unit 30, the additional CPU pack 22 is used. It comprises a clock driver, a ROM unit, a cache, a RAM unit, a system control unit, an IEEE 1394 unit, a PCI unit, an AGP unit, a power saving button, and a reset button in preparation for wrong operation. Accordingly it can operate as as an independent PC. In addition, because it exists as one pack, it is used as a low-power mobile CPU (Crusoe mobile Intel etc.), because it can be attached/separated as a pack shape, it can be used selectively in case of needs.

The extension graphic-sound pack 21 is used in a request of large capacity bandwidth which is difficult to process by the graphic-sound pack 25, the pack can be attached/separated also, accordingly it can be used selectively in case of needs.

Among the function packs, packs having a user request function are used by being inserted into the function extension unit 20, different module packs besides the above-mentioned packs can be used also as occasion demands.

The operation of the apparatus will now be described.

First, there is an ordinary telephone network (PSTN), a cable TV network, a leased-line internet network (ADSL, XDSL, ISDIN) etc. in communication cables which can be installed from outside to home. It is possible to use the internet and ordinary telephone function at the same time by a splitter 50 which divides the internet network and telephone network when the Internet and ordinary telephone are used at the same time.

It Is possible to perform TV watching and internet communication at the same time through the cable TV network and a cable modem by a splitter 60 which divides video and audio signals.

The splitters 50, 60 can exist as an external device, however they are placed inside the network interface pack 26 in the present invention.

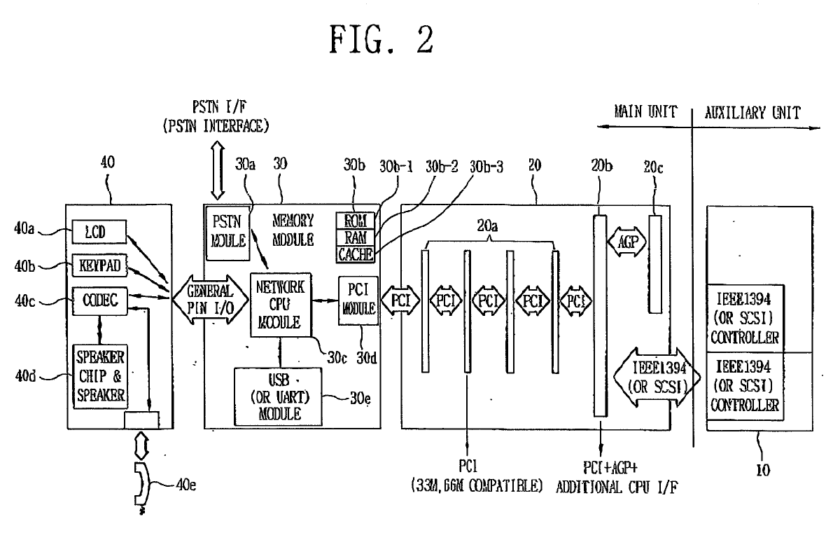

The above-mentioned apparatus will now be described in detail With reference to accompanying FIG. 2.

FIG. 2 is a block diagram illustrating a construction of the network connection apparatus using the internet phone of FIG. 1 in accordance with the present invention in detail. It comprises a LCD module 40a for displaying telephone numbers and various control information, a keypad module 40b for inputting telephone numbers etc., a codec module 40c for modulating an audio signal inputted from outside, a speaker module 40d for inputting and outputting audio, and a transmission/reception telephone module 40e for communicating with the other person.

The network CPIU unit 30 for performing telephone communication between the internet phone main unit 40 and a peripheral device, and connecting to the network comprises a network CPU module 30c controlling transmitted/received wire/wireless telephone communication and the network, a PSTN module 30a for detecting a ring signal inputted through the ordinary telephone network, converting an analog audio signal inputted from outside into a digital signal such as a PCM and transmitting it to the network CPU module 30c, a memory module 30b for storing an initialization code, an OS (Operating System) and a file, a PCI module 30d for arbitrating a PCI bus connecting data with various equipment installed in each slot of the function extending unit 20 while operating as a master/target according to conditions, and a USB (Universal Serial But or IEEE 1394) module 30e for performing extension connection with outer equipment (printer, camera etc.) easily.

The network CPU module 30c converts a signal inputted to the PSTN interface into a packet format, applies a protocol appropriate to a pertinent IP phone, performs routing about the inputted signal, and performs control/execution of a signal related to each PCI pack.

The memory module 30b comprises a ROM unit 30b-1 for storing an initialization code and an OS (Operating System) image, a RAM unit 30b-2 for storing an OS execute file and an application code, and a cache unit 30b-3 for improving a program execution speed or a communication execution speed.

The USB module 30e uses a USB interface which is largely used at the present time in order to connect to peripheral devices easily, it can use also the IEEE 1394 or a module according to different bus.

The network CPU unit 30 comprises a real-time OS which minimizes time delay due to an OS in network connection by strengthening a network protocol function such as a TCP/IP, performs a basic control operation required for telephone and network working.

The function extending unit 20 comprises slots 20a, 20b, 20c for contacting to the various function packs (depicted in FIG. 1) in order to extend functions later. The PCI bus used generally in order to interface the packs is set as a 66 MHz. The PCI bus is connected by switching, accordingly it can be easily changed into a bus having a different standard or a more improved bus in case of needs.

In comparison with the ordinary PC having several targets (slaves) in one PCI master, the each pack and network CPU can be both a master and a target by connecting to the network by the pack of the function extending unit.

The AGP slots 20c is for contacting to the extension graphic-sound pack 21 in order to provide better picture quality and sound quality, and the slot 20b is for contacting to the additional CPU pack 22 for operating an independent PC by controlling an equipment connected to the PCI slot and AGP slot.

As described above, the function extending unit 20 is operated as a back plane combining all equipment easily required in usage of the telephone/network/TV etc. Later, the back plane can be replaced with a more improved bus except the PCI or AGP.

When the network necessary condition is satisfied, it can be used instantly as a hub apparatus appropriate to usage circumstances of the user by contacting to auxiliary units and function extension packs 21˜26 additionally, and it can be connected to various peripheral devices wirelessly by contacting to the wireless LAN pack 24.

The operation of the above-mentioned apparatus will now be described in detail with reference to accompanying drawings.

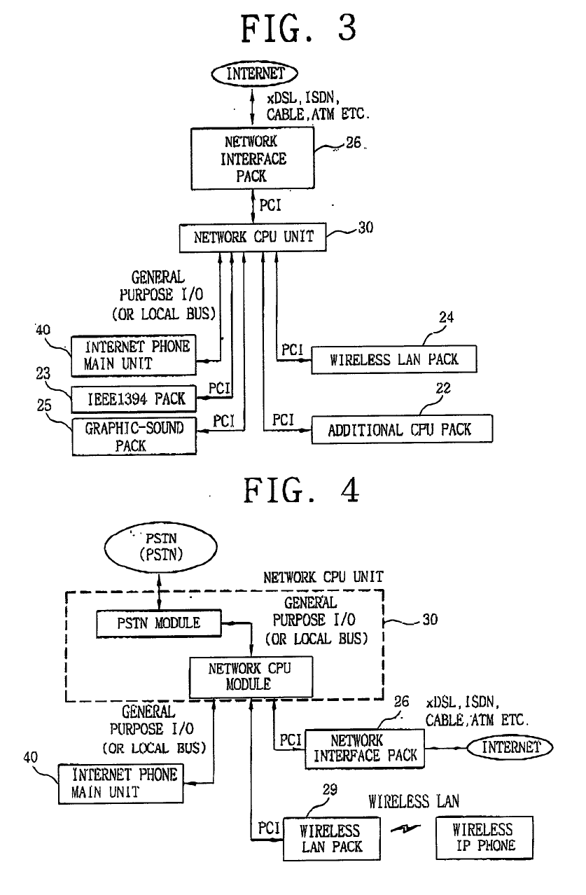

FIG. 3 is a block diagram illustrating a bus interface of each function pack contactable to the function extending unit in accordance with the present invention, the each function pack contacted to the internet phone main unit and function extending unit operates independently by being interfaced with the network CPU unit 30 by each PCI bus.

FIG. 4 is a block diagram illustrating a telephone communication method in accordance with the present invention, there is a method transmitting/receiving a telephone call through the PSTN and a method transmitting/receiving a telephone call through an IP phone.

First, the method receiving a telephone call through the PSTN will now be described.

When there is a telephone call from outside, the PSTN module 30a detects a ring signal. The detected ring signal is inputted to the network CPU module 30c, the main CPU unit 30c transmits the inputted signal to a codec 40c, the codec 40c rings a telephone bell by generating a tone. When the user picks up a receiver after listening the telephone bell, the telephone call is set-up, the inputted analog audio signal is sampled with PCM. The sampled PCM signal is divided into packets by being controlled by the network CPU module 30c, and is inputted to a wireless LAN pack 24 passing through a PCI bus. The inputted signal is transmitted to a wire/wireless telephone set of a certain IP address, accordingly a telephonic communication is performed.

A wireless telephonic communication will now be described with reference to accompanying FIG. 5.

FIG. 5 is a block diagram illustrating a telephone communication method using a wireless IP phone in accordance with the present invention. When data inputted to the network CPU module 30c is outputted to a wireless RF module, the wireless RF module transmits the inputted data to the certain wireless telephone set, accordingly a telephonic communication is performed.

In the other method, the PCM data inputted to the network CPU module 30c is converted into a PCI packet format after an IP packet conversion, and is transmitted to the wireless LAN pack 24. The wireless LAN pack 24 converts the transmitted PCI format data into a wireless LAN format, and transmits it to a wireless telephone set of a certain IP through a RF interface, accordingly the telephonic communication is performed.

Next, in transmission using the PSTN, when the user picks up the receiver of the wireless/wire telephone set or presses a telephonic communication button, the hook-up signal is transmitted to the network CPU 30 through the wireless LAN pack 24, accordingly connecting to the PSTN network is instantly performed. And, the user presses a telephone number of the other party after listening a dial-tone as sell as the ordinary telephone call, the user can talk over the telephone through the call set-up process, and the user can hang up when the telephonic communication is finished.

In reception through the IP network, in other words, when an audio signal is inputted as a packet format through the network interface pack 26, the call is received with not a telephone number but an IP address.

When the voice of the other party is, received as a packet format through the network internet pack 26, the packet is constructed as a packet format appropriate to the PCI bus in the PCI module 40d, and is inputted to the main CPU unit 40c. The network CPU module 40c materializes the call with exchange of a call set-up message by the VOIP standard protocol such as a H.323, accordingly the telephonic communication is performed.

When there is several wireless IP phones connected to the apparatus in accordance with the present invention and an IP address is allocated to the each wireless IP phone, direct telephone communication with the each wireless IP phone is possible by routing of the network CPU unit 30, the user can have effect which is much the same as installing several lines.

In telephone call through the IP network, the PSTN set as a default in telephone call is pressed by a certain keypad in the network CPU module 30c or is selected by an IP phone in a menu on a LCD screen, an IP address of the other party is inputted, an operation such as the VOIP-related protocol set-up etc. of the network CPU module 30c is processed, accordingly a telephonic communication is performed.

In telephone call through picture communication, a USB camera or a digital camera is connected to the USB module of the network CPU unit 30 or IEEE 1394 pack 23, a protocol corresponding to it is operated in the network CPU unit 30.

In the present invention, an internet access is possible only when the network interface pack 26 is contacted, there is two methods for accessing to the internet according to a communication subject, the network CPU unit 30 operates an application program in the one method, and the network CPU unit 30 only performs routing for accessing to the internet in the other method.

When a high quality network game or a PC basis network game is performed by the additional CPU pack 22, the network CPU unit 30 only performs the routing the network CPU unit 30 recognizes a destination IP address of an IP header is the additional CPU pack 22, and transmits it to the additional CPU pack 22 through the PCI bus.

The wireless IP phone or PC etc, connected to the wireless LAN with the IP outputs data inputted through the network interface pack 26 to the wireless LAN pack 24 after the network CPU unit 30 amends a MAC header part of the wireless LAN corresponding to the each IP address.

The terminal contacting to the outside through the wireless LAN pack 24 has an IP address as the wireless IP telephone or PC, apparatus (wireless keyboard, wireless mouse etc.) for communicating with the main body unit of the present invention can be separated or combined.

The IEEE 1394 pack 23 can be used when an apparatus which does not give much load to the network CPU unit 30 is contacted or it can be used by jointly contacting to an apparatus requiring lower bandwidth relatively through the wireless LAN pack, it is mainly used for contacting to digital media requiring large scale bandwidth such as a DVD or a digital video recorder with data transmission speed not less than 400 Mbps.

The additional CPU pack 22 has a minimum function operatable as an independent PC or a play station, it may not have an independent IP address by passing all network functions to the network CPU unit 30 or it may directly communicate with the network interface pack 26 by having an independent IP address according to the application program and PCI protocol.

When the network CPU unit 30 accesses to the internet as a subject, in the IP phone case, when a wrong call is connected or the user makes a call with the ordinary telephone set to an IP phone of the other party, the network CPU unit processes by operating the VOIP protocol, and contacts to the internet with the network interface pack 26 through the PCI bus. In web-surfing with the TV or network game, data transmitted from the network interface pack 26 is displayed with the TV or is sounded with an audio through the graphic sound pack 25 by using the execution program of the network CPU unit 30.

In addition, when the user wants to use data stored in a hard disk in home from outside or store data, the data is outputted or is stored in the IEEE 1394 pack by using the execution program of the network CPU.

As described above, the present invention can retrieve the internet by the telephone function and PC or home appliances such as the DVD etc. connected wirelessly, and can be connected to the peripheral devices.

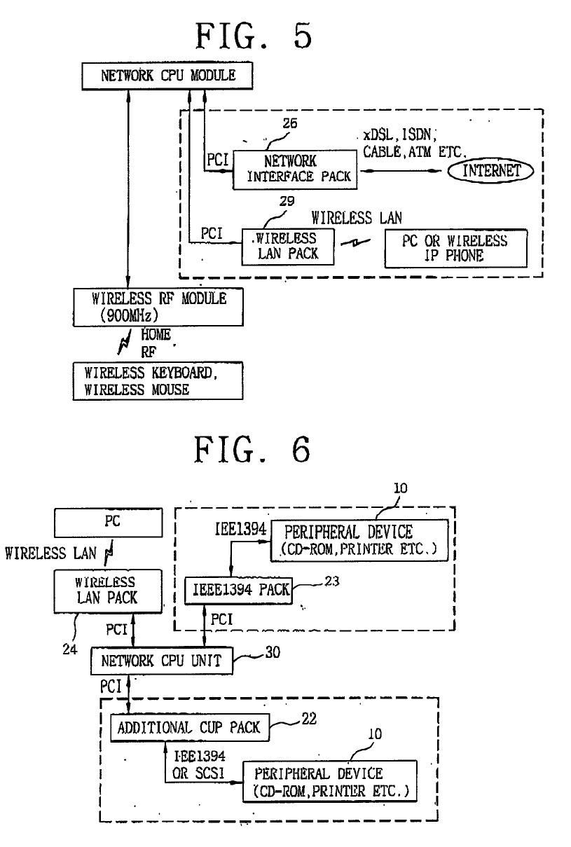

FIG. 6 is a block diagram illustrating a connection method of the main unit and peripheral device, the peripheral device 10 such as a CD-ROM, a printer, a hard disk etc. is used by being connected to the IEEE 1394 pack 23 or an IEEE 1394/SCSI bus of the additional CPU pack 22.

The IEEE 1394 pack is connected to the network CPU unit 30, the network CPU unit 30 is connected to the PC/DVD etc. wirelessly by being connected to the wireless LAN pack 24.

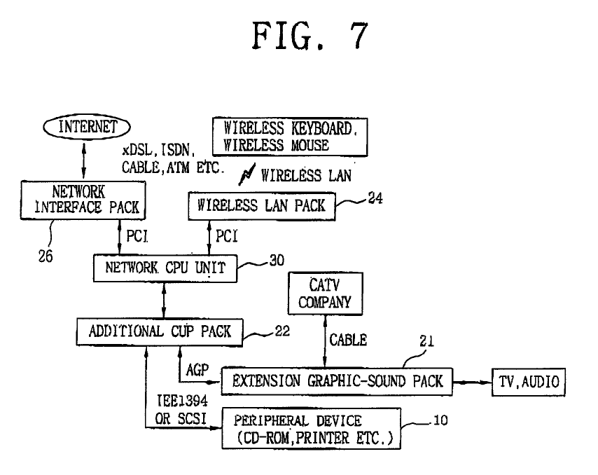

The other embodiment of the present invention will now be described with reference to accompanying FIG. 7.

FIG. 7 is a block diagram illustrating a method for extending performance of the CPU and graphic-audio in accordance with the present invention, when the user wants to play a network game, because the network game requires high resolution, it can not be displayed appropriately with the existing graphic-sound pack 25, accordingly the user can not play the game satisfactorily. Accordingly, when the large scale capacity is required such as a game play, the user can enjoy graphic and sound in high degree by using additional CPU 22 and extension graphic-sound pack 21.

In addition, when the user plays the network game on the PC, because a monitor of the ordinary PC is small and its resolution is low, interest of the user decreases, however the user can play more realistic game by playing with the TV, a wireless keyboard and a wireless mouse by inserting a wireless LAN pack. In addition, when the user plays the network game on the PC, because the game is played through the OS circumstances, the speed is slow, and it is unpleasant for the user, however the present invention uses an inserted game pack or, contacts to the network with the real time OS, accordingly the user can watch quicker moving picture in the present invention.

As described above, the present invention not only performs an ordinary telephone function, but also performs an international call or a long-distance call inexpensively by contacting to the network by using the internet phone, when the user wants to talk with a person related to a TV program over the phone while watching the TV program, the user can talk over the phone freely by clicking a mouse/remote controller. In addition, when one of a family talks over the phone, the other family member can use telephone function also regardless of it because each telephone set has an IP of itself.

In addition, by constructing a wireless network by operating various function packs as networking hubs, the present invention is possible to contact to a request equipment without performing wiring work, and performs functions of a multifunction digital unit such as a cable TV, a set top box, and a play station for PC etc. And, the apparatus in accordance with the present invention is cheaper, and has a lower power consumption than the network intergrated PC in accordance with the prior art, accordingly it is efficient. In addition, although the network circumstance is developed, because a pack can be changed according to it, it is easy to perform an upgrade.

What is claimed is:

1. A network connection apparatus using an internet phone, comprising:
an internet phone main unit usable as an ordinary telephone or an internet phone in accordance with an operation of a user;
a function extending unit for interfacing function packs performing an independent function respectively with a network CPU unit; and
a network CPU unit for controlling an audio signal transmitted/received through a PSTN and controlling a signal received from a network by controlling the internet phone main unit and function extending unit.

2. The network connection apparatus using the internet phone according to claim 1, wherein the internet phone main unit comprises;
a LCD module for displaying a telephone number and various control information;
a keypad module for inputting a telephone number and various information;
a codec module for modulating an audio signal inputted from outside;
a speaker module for inputting and outputting an audio; and
a tranceiver module for communicating with the other person.

3. The network connection apparatus using the internet phone according to claim 1 wherein the network CPU unit comprises:
a network CPU module for controlling/executing a signal inputted/outputted from/to the PSTN or network;
a PSTN module for detecting a ring signal inputted from the PSTN, converting an analog audio signal inputted form outside into a digital signal (PCM), and transmitting it to the network CPU module;
a memory module for storing a file and an application code for executing a signal inputted to the network CPU unit;
a PCI module for arbitrating various devices installed to slots of the function extending unit and data; and
a USB module for making extension-connection with a peripheral device easily.

4. The network connection apparatus using the internet phone according to claim 3, wherein the memory module comprises:
a ROM unit for storing data for initializing a state of the network CPU module;
a RAM unit for storing an application program for executing data transmitted to the network CPU module; and
a cache unit for improving execution speed of the network CPU module and communication execution speed.

5. The network connection apparatus using the internet phone according to claim 3, wherein the network CPU module converts a signal inputted form the PSTN into a packet format, adapts a protocol corresponding to a pertinent IP phone, performs routing in data transmission, controls/executes a signal related to each PCI pack.

6. The network connection apparatus using the internet phone according to claim 3, wherein the PCI module can directly input/output a packet to each function pack of the function extending unit, accordingly it can be a master and a target at the same time.

7. The network connection apparatus using the internet phone according to claim 1, wherein the network CPU unit contacts to the network by using a real-time operating system.

8. The network connection apparatus using the internet phone according to claim 1, wherein the function extending unit is constructed with a plurality of slots for inserting various function packs, and the number of slots can increase variably.

9. The network connection apparatus using the internet phone according to claim 1, wherein the function extending unit comprises:
a network interface pack for transmitting data inputted form an internet leased-line to the other function pack or the network CPU;
a wireless LAN pack for constructing a network with each terminal wirelessly;
an IEEE 1394 pack for connecting directly to a peripheral device having wide data transmission bandwidth;
a graphic-sound pack for displaying a graphic and an audio inputted from a communication cable or a network;
an extension graphic-sound pack for decreasing load of a CPU for outputting a graphic/audio in execution of a higher graphic and sound program and
an additional CPU pack for performing a large scale program which is difficult to perform with the network CPU module.

10. The network connection apparatus using the internet phone according to claim 9, wherein the additional CPU pack can operate as an independent PC, and comprises a power button for saving power and a reset button in preparation for wrong operation of a CPU.

11. The network connection apparatus using the internet phone according to claim 9, wherein the peripheral device connected to the IEEE 1304 pack can be a printer, a CD-ROM, a TV, a hard disk, or a DVD disk.

12. The network connection apparatus using the internet phone according to claim 9, wherein the function extending unit operates as a multifunction digital network unit.

13. The network connection apparatus using the internet phone according to claim 9, wherein the network connection apparatus using the internet phone can be miniaturized by combining common parts used in each function pack of the function extending unit into one.

14. A network connection method using an internet phone, comprising:
setting up a call when an audio signal is transmitted from outside through a PSTN/IP network;
sampling the transmitted analog audio signal with a PCM digital signal in the PSTN;
judging whether the call is connected by wire or wireless in accordance with an IP or a device address of the sampled PCM digital signal; and
transmitting the sampled PCM digital signal to the internet phone main unit when it is judged as wire or transmitting it to the PCI module when it is judged as wireless.

15. The network connection method using the internet phone according to claim 14, wherein the transmitting process for transmitting the PCM digital signal to the PCI module comprises the steps of:
converting the PCM digital signal transmitted to the PCI into an IP packet; and
transmitting the IP packet to an internet phone corresponding to a certain IP address through a wireless LAN pack.

16. The network connection method using the internet phone according to claim 15, wherein it is possible to communicate with each internet phone independently by routing of the network CPU unit when there is several internet phones and an independent IP address is allocated to the each internet phone in the transmitting step for transmitting the IP packet to the internet phone corresponding to the certain IP address.

17. The network connection method using the internet phone according to claim 14, wherein the setting~up process for setting up the call further comprises inputting the audio signal transmitted through the IP network through a network interface pack as a packet format.

18. In a method for originating a call by using an internet phone, a network connection method using an internet phone, comprising:
pressing a certain keypad, of a PSTN set as a default in a network CPU module by a user or selecting an internet phone in a menu on a LCD screen by a to user;
inputting an IP address of the other party; and
originating a call by setting up a VOIP-related protocol by the inputted IP address.

19. A network connection method using an internet phone, comprising:
accessing to the internet by a network CPU unit through a network interface pack when a user requests the Internet contact; and
displaying data received to the network interface pack on a TV through a graphic-sound pack by using an execution program etc. of the network CPU unit or listening data with an audio.

20. The network connection method using the internet phone according to claim 19, wherein displaying or listening process comprises the step of:
outputting all inputted/outputted signals to an additional CPU pack through a PCI bus by recognizing an additional CPU pack of a function extending unit as a destination IP address of an IP header by the network CPU unit when the bandwidth of the transmitted data is wide.

21. The network connection method using the internet phone according to claim 20, wherein the additional CPU pack may not have an independent IP address by passing all network functions to the network CPU unit or it may directly communicate with the network interface pack by having an independent IP address according to an application program and a PCI protocol.
